(19) United States
(12) Patent Application Publication
(10) Pub. No.: US 2021/0223460 A1
(43) Pub. Date: Jul. 22, 2021

(54) TRANSPARENT DISPLAY DEVICE AND BACKLIGHT MODULE

(71) Applicants: BEIJING BOE TECHNOLOGY DEVELOPMENT CO., LTD., Beijing (CN); BOE TECHNOLOGY GROUP CO., LTD., Beijing (CN)

(72) Inventors: Nanfang JIA, Beijing (CN); Long WANG, Beijing (CN); Yidan PENG, Beijing (CN)

(73) Assignees: BEIJING BOE TECHNOLOGY DEVELOPMENT CO., LTD., Beijing (CN); BOE TECHNOLOGY GROUP CO., LTD., Beijing (CN)

(21) Appl. No.: 17/264,334

(22) PCT Filed: Jul. 28, 2020
(86) PCT No.: PCT/CN2020/105162

§ 371 Date: Jan. 29, 2021

(30) Foreign Application Priority Data
Jul. 31, 2019 (CN) 201910701183.2

(51) Int. Cl. F21V 8/00; G02F 1/137

(52) U.S. Cl. CPC G02B 6/0046; G02F 1/13756; G02B 6/0076

(57) ABSTRACT

A transparent display device and a backlight module are disclosed. The transparent display device includes a backlight module and a scattering type display; the backlight module includes a first wedge light guide plate, the scattering type display panel includes a plurality of pixels, the first wedge light guide plate includes a first light incident surface, a first light emitting surface, and a first inclined surface arranged oppositely to the first light emitting surface, an included angle between the first light emitting surface and the first inclined surface is an acute angle, the scattering type display panel is located on a side of the backlight module where the first light emitting surface is located, and each of the plurality of pixels is configured to switch between a transparent state and a scattering state.

The application claims priority to the Chinese patent application No. 201910701183.2 filed on Jul. 31, 2019, the entire disclosure of which is incorporated herein by reference as part of the present application.

### TECHNICAL FIELD

Embodiments of the present disclosure relate to a transparent display device and a backlight module.

### BACKGROUND

A transparent display device is a display device that images displayed on the transparent display device and scenarios or articles behind the transparent display device can be seen simultaneously by users. Thus, the transparent display device can achieve the integration and interaction of the images displayed on the transparent display device and scenarios or articles behind the transparent display device, so as to offer users a completely new, abundant visual experience of strong presentation.

The transparent display device can be not only applied in common electronic equipment such as mobile phones, televisions and computers, but also in products such as automobile windows, refrigerator doors, shop windows, vending machines, and building windows.

### SUMMARY

Embodiments of the present disclosure provide a transparent display device and a backlight module. The transparent display device includes a backlight module and a scattering type display panel; the backlight module includes a first wedge light guide plate, the scattering type display panel includes a plurality of pixels. The first wedge light guide plate includes a first light incident surface, a first light emitting surface and a first inclined plane arranged oppositely to the first light emitting surface. The scattering type display panel is located on a side of the first wedge light guide plate where the first light emitting surface is located, each of the plurality of pixels is configured to switch between a transparent state and a scattering state. The transparent display device can be improved in the display uniformity, contrast ratio and display brightness while achieving transparent display.

At least one embodiment of the present disclosure provides a transparent display device. The transparent display device includes: a backlight module, including a first wedge light guide plate; and a scattering type display panel, including a plurality of pixels; the first wedge light guide plate includes a first light incident surface, a first light emitting surface, and a first inclined surface arranged oppositely to the first light emitting surface, an included angle between the first light emitting surface and the first inclined surface is an acute angle, the scattering type display panel is located on a side of the first wedge light guide plate where the first light emitting surface is located, and each of the plurality of pixels is configured to switch between a transparent state and a scattering state.

For example, in the transparent display device provided by an embodiment of the present disclosure, the first light emitting surface is a flat surface, and the first wedge light guide plate has a refractive index in a range from 1.45 to 2.

For example, in the transparent display device provided by an embodiment of the present disclosure, the transparent display device further includes a transparent layer, located between the scattering type display panel and the backlight module, the transparent layer is in direct contact with the first light emitting surface and the scattering type display panel respectively, and the transparent layer has a refractive index in a range from 1.30 to 1.50.

For example, in the transparent display device provided by an embodiment of the present disclosure, the transparent layer has a thickness in a range from 0.05 mm to 0.50 mm.

For example, in the transparent display device provided by an embodiment of the present disclosure, the backlight module further includes a second wedge light guide plate, including a second inclined surface, the first wedge light guide plate and the second wedge light guide plate are disposed at an interval, and the first inclined surface is arranged to be opposite to and approximately parallel to the second inclined surface.

For example, in the transparent display device provided by an embodiment of the present disclosure, the interval between the first wedge light guide plate and the second wedge light guide plate is an air interval.

For example, in the transparent display device provided by an embodiment of the present disclosure, the second wedge light guide plate further includes a second light incident surface which is arranged oppositely to the second inclined surface and is approximately parallel to the first light incident surface, and an included angle between the second light incident surface and the second inclined surface is an acute angle.

For example, in the transparent display device provided by an embodiment of the present disclosure, the transparent display device further includes a light source, arranged on the first light incident surface of the first wedge light guide plate and configured to emit light into the first wedge light guide plate from the first light incident surface, the first wedge light guide having a gradually decreased thickness from the a side where the light source is arranged to an opposite side; the light source has a light emitting half-angle in a range from 30 degrees to 65 degrees.

For example, in the transparent display device provided by an embodiment of the present disclosure, the first light incident surface is configured to receive the light emitted from the light source, the first inclined surface is configured to enable the light emitted from the light source to be totally reflected at the first inclined surface, and the first light emitting surface is configured to enable the light emitted from the light source to be emitted.

For example, in the transparent display device provided by an embodiment of the present disclosure, the light source includes a field sequential light source.

For example, in the transparent display device provided by an embodiment of the present disclosure, the scattering type display panel further includes an array substrate, including a first base substrate and a plurality of pixel electrodes arranged on the first base substrate; an opposed substrate, cell-assembled with the array substrate; and a liquid crystal layer, located between the array substrate and the opposed substrate; the liquid crystal layer includes polymer stabilized liquid crystal or polymer dispersed liquid crystal, each of the plurality of pixel electrodes is configured to drive the polymer stabilized liquid crystal or the polymer dispersed liquid crystal to switch between a transparent state and a scattering state.

For example, in the transparent display device provided by an embodiment of the present disclosure, the opposed substrate includes a second base substrate which has a refractive index in a range from 1.45 to 2.

For example, in the transparent display device provided by an embodiment of the present disclosure, a shape of a cross section of the first wedge light guide plate is a trapezoid, a long base edge of the trapezoid is in a range from 1 mm to 10 mm, and a short base edge of the trapezoid is in a range from 0.1 mm to 2 mm.

At least one embodiment of the present disclosure further provides a backlight module, which includes a first wedge light guide plate, including a first light incident surface, a first light emitting surface, and a first inclined surface arranged oppositely to the first light emitting surface, an included angle between the first light emitting surface and the first inclined surface being an acute angle; and a second wedge light guide plate including a second inclined surface; the first wedge light guide plate and second wedge light guide plate are disposed at an interval, and the first inclined surface is arranged to be opposite to and approximately parallel to the second inclined surface.

For example, in the backlight module provided by an embodiment of the present disclosure, the interval between the first wedge light guide plate and the second wedge light guide plate is an air interval.

For example, in the backlight module provided by an embodiment of the present disclosure, the second wedge light guide plate further includes a second light incident surface arranged oppositely to the second inclined surface and is approximately parallel to the first light incident surface, and an included angle between the second light incident surface and the second inclined surface is an acute angle.

For example, in the backlight module provided by an embodiment of the present disclosure, the first light emitting surface is a flat surface, and the wedge light guide plate has a refractive index in a range from 1.45 to 2.

For example, in the backlight module provided by an embodiment of the present disclosure, the first light emitting surface is provided with no mesh dot.

For example, in the backlight module provided by an embodiment of the present disclosure, a shape of a cross section of the first wedge light guide plate is a trapezoid, a long base edge of the trapezoid is in a range from 1 mm to 10 mm, and a short base edge of the trapezoid is in a range from 0.1 mm to 2 mm.

For example, in the backlight module provided by an embodiment of the present disclosure, the backlight module further includes a light source, arranged on the first light incident surface of the first wedge light guide plate and is configured to emit light into the first wedge light guide plate from the first light incident surface; the first light incident surface being configured to receive the light emitted from the light source; the first inclined surface being configured to enable the light emitted from the light source to be totally reflected at the first inclined surface; and the first light emitting surface being configured to enable the light emitted from the light source to be emitted.

### BRIEF DESCRIPTION OF THE DRAWINGS

In order to more clearly illustrate the technical solution of the embodiments of the present disclosure, the drawings of the embodiments will be briefly described in the following. It is obvious that the described drawings below are only related to some embodiments of the present disclosure without constituting any limitation thereto.

FIG. 1 is a schematic diagram of a transparent display device adopting a lateral light incident mode;

FIG. 2 is a schematic diagram of a transparent display device adopting a projection type light incident mode;

FIG. 3 is a schematic diagram of a transparent display device according to an embodiment of the present disclosure;

FIG. 4 is a schematic diagram of a scattering type display panel according to an embodiment of the present disclosure;

FIG. 5 is a schematic diagram showing variations of the far and near brightness with the refractive index of the transparent layer, of a transparent display device, adopting a light source with a light emitting half angle of 60 degrees, according to an embodiment of the present disclosure;

FIG. 6 is a schematic diagram showing variations of the far and near brightness with the refractive index of the transparent layer, of another transparent display device, adopting a light source with a light emitting half angle of 45 degrees, according to an embodiment of the present disclosure; and

FIG. 7 is a schematic diagram of a backlight module according to an embodiment of the present disclosure.

### DETAILED DESCRIPTION

In order to make objectives, technical details and advantages of the embodiments of the present disclosure more clearly, the technical solutions of the embodiments will be described in a clearly and fully understandable way in connection with the drawings related to the embodiments of the present disclosure. Apparently, the described embodiments are just a part but not all of the embodiments of the present disclosure. Based on the described embodiments herein, those skilled in the art can obtain other embodiment(s), without any inventive work, which should be within the scope of the present disclosure.

Unless otherwise defined, all the technical and scientific terms used herein have the same meanings as commonly understood by one of ordinary skill in the art to which the present disclosure belongs. The terms “first,” “second,” etc., which are used in the present disclosure, are not intended to indicate any sequence, amount or importance, but distinguish various components. Also, the terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may comprise an electrical connection, directly or indirectly.

A transparent display device may include: (1) a transparent display device based on a conventional liquid crystal display panel; (2) a transparent display device based on a light-emitting diode (LED) display panel; (3) a transparent display device based on an organic light-emitting diode (OLED) display panel; and (4) a transparent display device based on a scattering type display panel. In the study, inventor(s) of the present application have noted that because the conventional liquid crystal display panel includes film layers such as polarizers, light transmittance of the transparent display device based on conventional liquid crystal display panel is less than 10%, and the brightness and utilization of light of the transparent display device based on conventional liquid crystal display panel is relatively low; because the size of the light-emitting diode is relatively large, a size of the pixel of the transparent display device based on light-emitting diode display panel is suitable for an oversized transparent display device. Additionally, the transparent display device based on organic light-emitting diode (OLED) display panel has a high cost and a service life difficult to guarantee. Because field sequential light source matching and quick response liquid crystals (for example, polymer-dispersed liquid crystals and polymer stabilized liquid crystals) are used in the scattering type transparent display technology without polarizers and color filters, the transparent display device based on scattering type display panel has a high transmittance (more than 80%); and has the similar manufacture process to conventional liquid crystal display panels, with a low cost, relatively high reliability and relatively long service life.

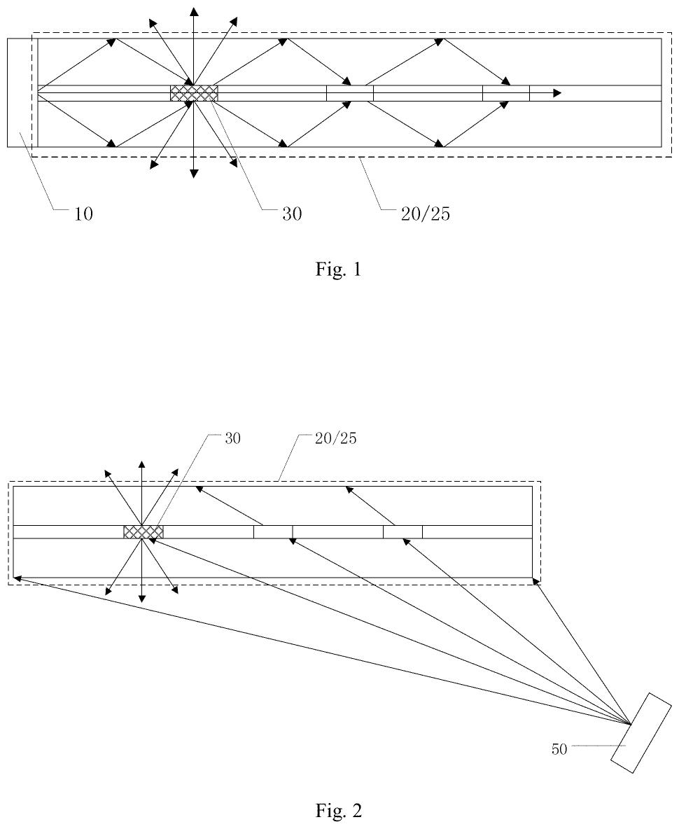

The light incident mode of this type of transparent display device based on scattering type display panel usually adopts a lateral light incident mode and a projection type light incident mode. FIG. 1 is a schematic diagram of a transparent display device adopting a lateral light incident mode. As illustrated by FIG. 1, a light source 10 is arranged on a lateral side of a liquid crystal cell 25 of a scattering type display panel 20 and emits light which enters the liquid crystal cell 25 and is totally reflected on the interface of the liquid crystal cell 25 with external environment, and is scattered when encountering a display pixel 30 in a scattering state and then can be emitted out from the liquid crystal cell after scattered, thus displaying. However, as illustrated by FIG. 1, with the increase in its distance from the light source 10, the light has a gradually decreased intensity, so that the light intensity at an end of the liquid crystal cell 25 close to the light source 10 is larger than that at an end of the liquid crystal cell 25 away from the light source 10. Therefore, in the transparent display device adopting a lateral light incident mode, there are problems such as poor display uniformity and poor contrast ratio; moreover, the larger size the transparent display device has, the poorer display uniformity it has. FIG. 2 is a schematic diagram of a transparent display device adopting a projection type light incident type. As illustrated by FIG. 2, a projection type light source 50 is arranged on a side of the scattering type display panel 20 and emits light in a direction which has a certain angle with the scattering type display panel 20, and emits light which enters from a side of the scattering type display panel 20. When encountering the display pixel 30 in a scattering state, the light emitted by the projection type light source 50 is scattered, and then the scattered light can be emitted out from the other side of the scattering type display panel 20. Although the display device with projection type light entrance can avoid to some extent the problem of the poor display uniformity described above, its large volume make it impossible to achieve miniaturization and integration.

At least one embodiment of the present disclosure provides a transparent display device. The transparent display device includes a backlight module including a first wedge light guide plate, and a scattering type display panel including a plurality of pixels. The first wedge light guide plate includes a first light incident surface, a first light emitting surface and a first inclined plane arranged oppositely to the first light emitting surface. The scattering type display panel is located on a side of the first wedge light guide plate where the first light emitting surface is located, each of the plurality of pixels is configured to switch between a transparent state and a scattering state. The transparent display device can be improved in the display uniformity, contrast ratio and display brightness while achieving transparent display.

At least one embodiment of the disclosure further provides a backlight module, which includes a first wedge light guide plate and a second wedge light guide plate. The first wedge light guide plate includes a first light incident surface, a first light emitting surface, and an inclined surface arranged oppositely to the first light emitting surface, and the second wedge light guide plate includes a second inclined surface, the first wedge light guide plate and the second wedge light guide plate are disposed at an interval, the first inclined surface is arranged to be opposite to and be approximately parallel to the second inclined surface. The backlight module can be used for the transparent display device, and can avoid the deviation and deformation of scenarios and articles behind the transparent display device while improving the display uniformity, contrast ratio and display brightness.

Hereinafter, the transparent display device and backlight module provided by embodiments of the disclosure will be described in detail with reference to the drawings.

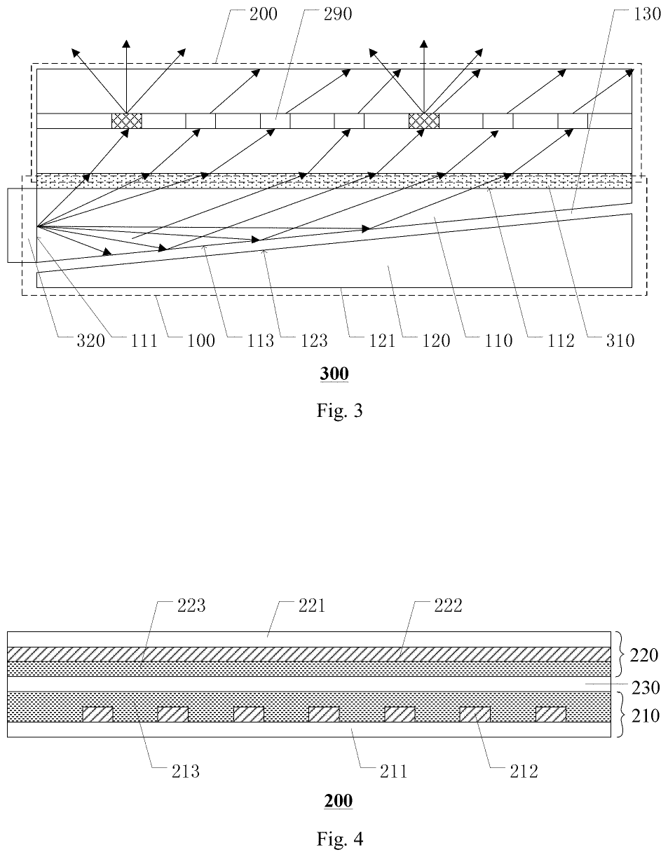

FIG. 3 is a schematic diagram of a transparent display device according to an embodiment of the disclosure. As illustrated by FIG. 3, the transparent display device 300 includes a backlight module 100 including a first wedge light guide plate 110, and a scattering type display panel 200 including a plurality of pixels 290. The first wedge light guide plate 110 includes a first light incident surface 111, a first light emitting surface 112 and a first inclined surface 113 arranged oppositely to the first light emitting surface 112, an included angle between the first light emitting 112 and the first inclined surface is an acute angle. The scattering type display panel 200 is located on a side of the first wedge light guide 110 where the first light emitting surface 112 is located, and each of the plurality of pixels 290 is configured to switch between a transparent state and a scattering state. It is to be explained that there is no mesh dot structure provided on the first light emitting surface 112, and no scattering sheet is arranged between the first light emitting surface 112 and the scattering type display panel 200. Additionally, there is either no mesh dot structure arranged in the first inclined surface 113.

In some examples, as illustrated by FIG. 3, the first light incident surface 111 can receive the light emitted by a light source, the first inclined surface 113 enables the light emitted by a light source to be totally reflected at the first inclined surface, and the light emitting surface 112 makes it possible for the light emitted by a light source to be emitted.

In the transparent display device provided in the embodiment, on the first light incident surface is arranged a light source emitting light which can enter the first wedge light guide plate from the first light incident surface. A portion of the light from the first light incident surface is emitted directly from the first light emitting surface, and the other portion of the light is emitted to an end of the first wedge light guide plate away from the first light incident surface through the total reflection by the first inclined surface and is emitted from the first light emitting surface on the end of the first wedge light guide plate away from the first light incident surface. Therefore, the first wedge light guide plate can improve the light emitting uniformity of the backlight module without scattering sheet and light uniformity plate arranged. The light emitted from the first light emitting surface enters directly the scattering type display panel, passes directly through the pixels when the pixels is in a transparent state, and is scattered at the pixels when the pixels is in a scattering state. The scattered light can be emitted from the scattering type display panel, thus displaying images on the side of the scattering type display panel away from the first wedge light guide plate. At the same time, the light emitted or reflected by the scenarios or articles on the side of the first wedge light guide plate away from the scattering type display panel can be emitted from the first inclined surface of the first wedge light guide plate into the first wedge light guide plate and the scattering type display panel, and then can be emitted from the scattering type display panel, thus achieving transparent display on the side of the scattering type display panel away from the first wedge light guide plate. Thus, the transparent display device can be improved in the display uniformity, contrast ratio and display brightness while achieving transparent display.

In some examples, as illustrated by FIG. 3, the first light emitting surface 112 is a flat surface, and namely there is no mesh dot structure provided on the first light emitting surface 112; the first wedge light guide plate 110 has a refractive index in a range from 1.45 to 2. Additionally, there is either no mesh dot structure provided on the first inclined surface 113.

For example, the material of the first wedge light guide plate 110 is selected from materials of high light transmittance (for example, materials of light transmittance of more than 90%), such as, polymethylmethacrylate (PMMA), acrylic, polycarbonate or glass.

For example, the first wedge light guide plate 110 has materials selected from glass with the refractive index of 1.51314.

In some examples, as illustrated by FIG. 3, the transparent display device 300 also includes a transparent layer 310 located between the scattering type display panel 200 and the backlight module 100. The transparent layer 310 is in direct contact with the first light emitting surface 112 and the scattering type display panel 200 respectively, and has a refractive index in a range from 1.30 to 1.50. Here, the transparent layer 310 has the refractive index range compatible with that of the first wedge light guide plate 110, thus further enhancing the brightness uniformity of the transparent display device.

In some examples, as illustrated by FIG. 3, the transparent layer 310 has a refractive index in the range from 1.32 to 1.40. Upon having a refractive index in the range from 1.32 to 1.40, the transparent layer 310 can be better compatible with the first wedge light guide plate with a refractive index in the range from 1.49 to 1.52, thus achieving a better brightness uniformity.

In some examples, the material of the transparent layer 310 can be transparent optical glue such as liquid transparent optical glue.

In some examples, the transparent layer 310 has a thickness in a range from 0.05 mm to 0.50 mm; further, the transparent layer 310 has a thickness in a range from 0.08 mm to 0.12 mm.

In some examples, as illustrated by FIG. 3, the backlight module 100 further includes a second wedge light guide plate 120 including a second inclined surface 123, the first wedge light guide plate 110 and the second wedge light guide plate 120 are disposed at an interval, and the first inclined surface 113 is arranged to be opposite to and approximately parallel to the second inclined surface 123. It is to be noted that the above expression “approximately parallel to” includes the case that the first inclined surface is completely parallel to the second inclined surface, and also the case that the included angle between the first inclined surface and the second inclined surface is less than 10.

In the transparent display device provided in the example, there is the second wedge light guide plate arranged, the first inclined surface is arranged to be opposite to and approximately parallel to the second inclined surface, and the light emitted or reflected by the scenarios or articles on a side of the second wedge light guide plate away from the scattering type display panel can firstly pass through the second wedge light guide plate and the first wedge light guide plate, then is emitted again to the scattering type display panel and is emitted out from the scattering type display panel; which makes it possible for the scenarios or articles on a side of the second wedge light guide plate away from the scattering type display panel to have only extremely small position offset and even no position offset after passing through the transparent display device, thus enhancing the display quality of the transparent display device.

In some examples, as illustrated by FIG. 3, the interval between the first wedge light guide plate 110 and the second wedge light guide plate 120 is an air interval 130. Certainly, the embodiments of the disclosure include but are not limited thereto. The interval between the first wedge light guide plate and the second wedge light guide plate can be formed by other materials filled, as long as it is possible for the light entering from the first light incident surface to be totally reflected at the first inclined surface.

In some examples, as illustrated by FIG. 3, the second wedge light guide plate 120 also includes a second light incident surface 121 which is arranged oppositely to the second inclined surface 123, and namely the second light incident surface 121 and the second inclined surface 123 are two opposite surfaces of the second wedge light guide plate 120. The second light incident surface 121 is also a surface of the second wedge light guide plate 120 away from the scattering type display panel 200. The included angle between the second light incident surface 121 and the second inclined surface 123 is an acute angle, and the second light incident surface 121 is approximately parallel to the first light emitting surface 112. For example, the first light emitting surface 112 is approximately parallel to the second light incident surface 121, and the first inclined surface 112 is approximately parallel to the second inclined surface 123. And for another example, the first light emitting surface 112 is approximately parallel to the scattering type display panel 200. For this, the transparent display device provided in the example can further ensure that the scenarios or articles on a side of the second wedge light guide plate away from the scattering type display panel have only extremely small position offset and even no position offset after passing through the transparent display device, thus further enhancing the display quality of the transparent display device.

For example, the first included angle between the first inclined surface 113 and the first light emitting surface 112 is approximately equal to the second included angle 220 between the second inclined surface 123 and the second light incident surface 121.

In some examples, as illustrated by FIG. 3, the transparent display device 300 further includes a light source 320 which is arranged on the first light incident surface 111 of the first wedge light guide plate 110 and is configured to emit light from the first light incident surface 111 into the first wedge light guide plate 110. From one side where the light source 320 is arranged to its opposite side, the first wedge light guide plate has a gradually decreased thickness, and the light source 320 has a light emitting half angle in a range from 30 degrees to 65 degrees. For example, the light source 320 has a light emitting half angle in a range from 55 degrees to 65 degrees, such as 60 degrees, and namely the light source 320 can use a common light emitting half angle. Additionally, in some examples, the light source 320 can have a light emitting half angle in a range from 45 degrees to 50 degrees, for example 45 degrees, thus further improving the display effect.

For example, it is seen from FIG. 3 that the light source 320 is arranged on a side of the first wedge light guide plate 110, and thus the backlight module 100 of the transparent display device 300 is a side-entry type backlight module. Furthermore, the light source 320 is arranged on a side of larger thickness of the first wedge light guide plate 110. For example, from the side where the light source 320 is arranged to its opposite side, the first wedge light guide plate 110 has a gradually decreased thickness. In some examples, the light source 320 can be a field sequential light source, and namely the light source can emit light of different colors successively. For example, the light source 320 can emit red, green and blue light at a frequency of 180 hz, and namely the light source 320 can be a field sequential light source cyclically emitting red, green and blue light. When the light source 320 emits red light, it is needed for the pixels displaying red color to be in a scattering state under electric driving and for the other pixels to be in a transparent state. When the light source 320 emits green light, it is needed for the pixels displaying green color to be in a scattering state under electric driving and for the other pixels to be in a transparent state. When the light source 320 emits blue light, it is needed for the pixels displaying blue color to be in a scattering state under electric driving and for the other pixels to be in a transparent state. Thus, the transparent display device can perform light emitting display at a frame rate of 60 hz.

In some examples, as illustrated by FIG. 3, a shape of the cross section of the first wedge light guide plate is trapezoid, and a long base edge of the trapezoid has a length in a range from 1 mm to 10 mm and namely the first light incident surface 111 has a size in the range from 1 mm to 10 mm in the direction vertical to the first light emitting surface 112, a short base edge of the trapezoid has a length in a range from 0.1 mm to 2 mm and namely a first top surface 114 of the first wedge light guide plate 110 opposite to the first light incident surface 111 has a size in the range from 0.1 mm to 2 mm in the direction vertical to the first light emitting surface 112. And for example, when the transparent display device is that of about 8 inches, the long base edge of the trapezoidal cross section of the first wedge light guide plate has a length in the range from 1.6 mm to 5 mm, and the short base edge of the trapezoidal cross section of the first wedge light guide plate has a length in the range from 0.1 mm to 1 mm. It is to be explained that the height of the above trapezoid has the same size as or nearly the same size as the width of the scattering type display panel, and is not less than the width of the display area of the scattering type display panel.

In some examples, as illustrated by FIG. 3, a shape of the cross section of the first wedge light guide plate 110 is trapezoid, and a long base edge of the trapezoid has a length in the range from 2.8 mm to 3.2 mm and namely the first light incident surface 111 has a size in the range from 2.8 mm to 3.2 mm in the direction vertical to the first light emitting surface 112, and a short base edge of the trapezoid has a length in the range from 0.48 mm to 0.52 mm and namely the first top surface 114 of the first wedge light guide plate 110 opposite to the first light incident surface 111 has a size in the range from 0.48 mm to 0.52 mm in the direction vertical to the first light emitting surface 112. The height of the the trapezoid has a size in the range from 110 mm to 130 mm, and namely the first light emitting surface 112 has a size in the range from 110 mm to 130 mm in the direction vertical to the first light incident surface 111.

For example, the first light incident surface 111 has a size of 3 mm in the direction vertical to the first light emitting surface 112, and the first light emitting surface 112 has a size of 120 mm in the direction vertical the first light incident surface 111. The first wedge light guide plate 110 further includes the first top surface 114 opposite to the first light incident surface 111, and the first top surface 114 has a size of 0.5 mm in the direction vertical to the first light emitting surface 112.

FIG. 4 is a schematic diagram of a scattering type display panel according to an embodiment of the disclosure. As illustrated by FIG. 4, the scattering type display panel 200 further includes an array substrate 210, a opposed substrate 220 and a liquid crystal layer 230 between the array substrate 210 and the opposed substrate 220, the array substrate 210 and the opposed substrate 220 are cell-assembled. The array substrate 210 includes a first base substrate 211 and a plurality of pixel electrodes 212 disposed on the first base substrate 211. The liquid crystal layer 230 includes polymer stabilized liquid crystal or polymer dispersed liquid crystal, each of the plurality of pixel electrodes 212 can drive the polymer stabilized liquid crystal or the polymer dispersed liquid crystal to switch between a transparent state and a scattering state. The scattering type display panel provided in the example is a scattering type liquid crystal display panel. Thus the scattering type liquid crystal display panel has a more mature and reliable manufacture technology, with the transparent display device having a lower manufacture cost and a high stability and long service life.

For example, a second base substrate 221 has a refractive index in a range from 1.45 to 2.

In some examples, as illustrated by FIG. 4, the opposed substrate 220 includes the second base substrate 221 which has a refractive index range in a range from 1.45 to 2. For this, when the pixels are in a transparent state, the light emitted from the first light emitting surface directly passes through the pixels and is totally deflected on the intersection between the second base substrate and external environment, without the pixels in a transparent state performing light emitting display. It is to be explained that the pixels in a transparent state can perform transparent display through the light emitted or reflected by the scenarios or articles on a side of the second wedge light guide plate away from the scattering type display panel.

For instance, the first base substrate 211 can be made from the same materials as and has the same refractive index as the second base substrate 221.

In some examples, as illustrated by FIG. 4, the array substrate 210 further includes a first alignment layer 213 located on a side of the pixel electrode 212 away from the first base substrate 211, which can be used for the alignment of liquid crystal molecules in the crystal layer 230. For example, the array substrate further includes a circuit structure (not shown) for driving the pixel electrodes, which can be designed by reference to conventional designs and will not be described in the embodiment of the disclosure.

In some examples, as illustrated by FIG. 4, the opposed substrate 220 further includes a common electrode 222 located on the second base substrate 221 and close to the liquid crystal layer 230, and a second alignment layer 223 located on the common electrode layer 222 and away from the second base substrate 221. The second alignment layer 223 is used to align jointly the liquid crystal molecules in the liquid crystal layer 230, in conjunction with the first alignment layer 213. The common electrode 222 is used to form an electrical field with the pixel electrodes 212 to drive the liquid crystals in the liquid crystal layer 230. Certainly, the embodiments of the disclosure include but are not limited to the common electrode being located on the opposed substrate, and the common electrode also can be arranged on the array substrate.

For example, the first base substrate and second base substrate can be glass substrate, quartz substrate, etc. The first base substrate has a thickness in the range from 300 to 1000 micron, and the second base substrate has a thickness in the range from 300 to 1000 micron.

For example, the pixel electrode and common electrode can be made from transparent oxide semiconductor materials such as indium tin oxide (ITO). When the pixel electrodes and common electrode are made from indium tin oxide, the pixel electrodes have a thickness in the range from 0.02 micron to 0.1 micron, and the common electrode has a thickness in the range from 0.02 micron to 0.1 micron.

For example, the first alignment layer and the second alignment layer can be made from polyimide materials, the first alignment layer has a thickness in the range from 0.05 micron to 0.12 micron, and the second alignment layer has a thickness in the range from 0.05 micron to 0.12 micron.

In an example of the disclosure is provided a transparent display device. The first light incident surface of the first wedge light guide plate used in the transparent display device has a size of 4 mm in the direction vertical to the first light emitting surface. The first light emitting surface has a size of 120 mm in the direction vertical to the first light incident surface, and the first top surface has a size of 1 mm in the direction vertical to the first light emitting surface. Here, the uniformity in the direction of light propagation can be used for the analysis of the brightness uniformity of the transparent display device. According to simulation results, the transparent display device has an optical power of 1814 W in a range of 5 mm from a far light source in the display area, an optical power of 1766 W in a range of 5 mm from the middle region in the display area, and an optical power of 1615 W in a range of 5 mm from a near light source in the display area. It is roughly estimated from this that the transparent display device has a display brightness uniformity of 1615/1814=89% which is remarkably higher than that of the transparent display device with lateral light incidence. Moreover, according to verification results (tested by the CA210 instrument) obtained by using wedge roughly-machined PMMA (polymethylmethacrylate) as the first wedge light guide plate, the transparent display device can achieve the display effect of the brightness of more than 180 nit. It can be seen that the transparent display device provided in the embodiments of the disclosure has a high display brightness uniformity and high display brightness.

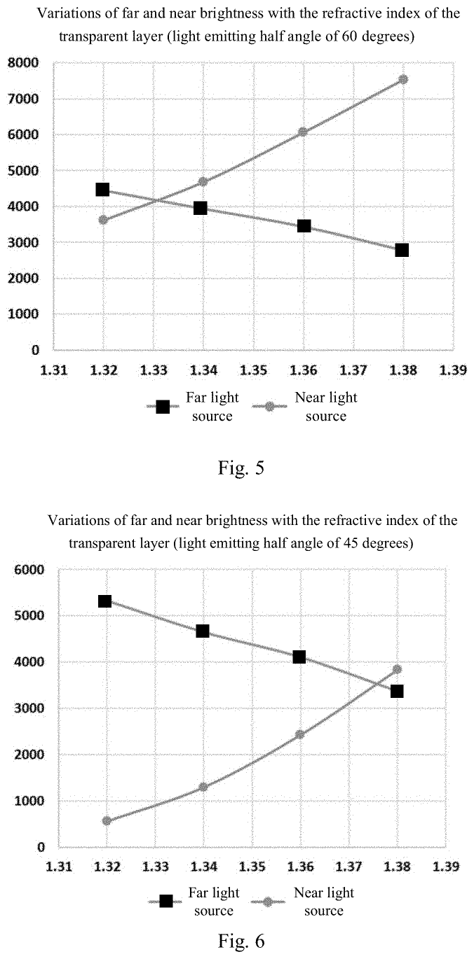

FIG. 5 is a schematic diagram showing variations of the far and near brightness with the refractive index of the transparent layer, of a light source with a light emitting half angle of 60 degrees used in a transparent display device according to an embodiment of the disclosure; and FIG. 6 is a schematic diagram showing variations of the far and near brightness with the refractive index of the transparent layer, of a light source with a light emitting half angle of 45 degrees used in another transparent display device according to an embodiment of the disclosure. The transparent display devices shown in FIG. 5 and FIG. 6 use the first wedge light guide plate whose first light incident surface has a size of 3 mm in the direction vertical to the first light emitting surface, with the first light emitting surface having a size of 120 mm in the direction vertical to the first light incident surface and the first top surface having a size of 0.5 mm in the direction vertical to the first light emitting surface. It is to be explained that the far light sources in FIG. 5 and FIG. 6 mean the brightness of the locations away from the light source in the display area of the transparent display device, and the near light sources in FIG. 5 and FIG. 6 mean the brightness of the locations close to the light source in the display area of the transparent display device.

As illustrated by FIG. 5, when the light source has a light emitting half-angle of 60 degrees, with the refractive index of the transparent layer of 1.32-1.35, the brightness of the locations away from the light source differs slightly from that of the locations close to the light source, in the display area of the transparent display device; with the refractive index of the transparent layer of 1.33, the brightness of the locations away from the light source is equal to that of the locations close to the light source, in the display area of the transparent display device.

As illustrated by FIG. 6, when the light source has a light emitting half-angle of 45 degrees, with the refractive index of the transparent layer of 1.36-1.38, the brightness of the locations away from the light source differs slightly from that of the locations close to the light source, in the display area of the transparent display device; with the refractive index of the transparent layer of 1.37-1.38, the brightness of the locations away from the light source is approximately equal to that of the locations close to the light source, in the display area of the transparent display device.

In some examples, the transparent display device can be electric products with display function such as cellphones, notebook computers and tablet computers. Additionally, the transparent display device can also be products such as automobile windows, refrigerator doors, shop windows, vending machines and building windows.

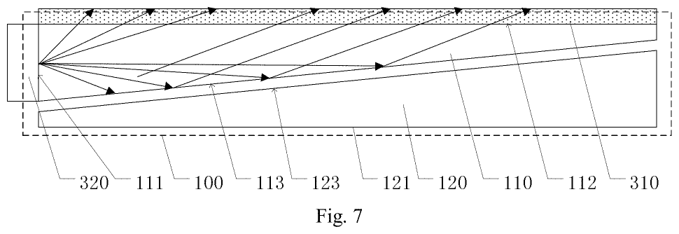

FIG. 7 is a schematic diagram of a backlight module according to an embodiment of the disclosure. As illustrated by FIG. 7, the backlight module 100 includes the first wedge light guide plate 110 and the second wedge light guide plate 120 which are arranged to be separated from each other, the first wedge light guide 110 includes the first light incident surface 111, the first light emitting surface 112 and the first inclined surface 113 arranged oppositely to the first light emitting surface 112, with the included angle between the first light emitting surface 112 and the first inclined surface 113 being an acute angle. The second wedge light guide plate 120 includes the second inclined surface 123, the first light guide plate 110 and the second wedge light guide plate 120 are disposed at an interval, and the first inclined surface 113 is arranged to be opposite to and approximately parallel to the second inclined surface 123. It is to be explained that the above expression “approximately parallel to” includes the first inclined surface being completely parallel to the second inclined surface, and also includes the included angle between the first inclined surface and the second inclined surface of less than 10.

In some examples, as illustrated by FIG. 7, the first light incident surface 111 can receive the light emitted from the light source, the first inclined surface 113 enables the light emitted from the light source to be totally reflected at the first inclined surface, and the first light emitting surface 112 enables the light emitted from the light source to be emitted.

The backlight module provided in the embodiment on the one hand can improve the uniformity of light emitting intensity so as to enhance the display uniformity and contrast ratio of the transparent display device using the backlight module, and on the other hand can be used for transparent display and makes it possible for the scenarios or articles on a side of the second wedge light guide plate away from the display panel (for example, the scattering type display panel described above) to have only extremely small position offset and even no position offset after passing through the transparent display device, thus enhancing the display quality of the transparent display device using the backlight module.

In some examples, as illustrated by FIG. 7, the interval between the first wedge light guide plate 110 and the second wedge light guide plate 120 is an air interval 130. Certainly, the embodiments of the disclosure include but are not limited thereto. The interval between the first wedge light guide plate and the second wedge light guide plate can be formed by other materials filled, as long as it is possible for the light entering from the first light incident surface to be totally reflected at the first inclined surface.

In some examples, as illustrated by FIG. 7, the second wedge light guide plate 120 also includes the second light incident surface 121 which is arranged oppositely to the second inclined surface 123, and namely the second light incident surface 121 and the second inclined surface 123 are two opposite surfaces of the second wedge light guide plate 120. The second light incident surface 121 is also the surface of the second wedge light guide plate 120 away from the scattering type display panel 200. The included angle between the second light incident surface 121 and the second inclined surface 123 is an acute angle, and the second light incident surface 121 is approximately parallel to the first light incident surface 112. For this, the backlight module provided in the example can further ensure that the scenarios or articles on a side of the second wedge light guide plate away from the first wedge light guide plate have only extremely small position offset and even no position offset after passing through the backlight module, thus further enhancing the display quality of the transparent display device using the backlight module.

For example, the first included angle between the first inclined surface 112 and the first light emitting surface 112 is approximately equal to the second included angle 220 between the second inclined surface 123 and the second light incident surface 121.

In some examples, as illustrated by FIG. 7, a shape of the cross section of the first wedge light guide plate is trapezoid, and a long base edge of the trapezoid has a length in the range from 1 mm to 10 mm and namely the first light incident surface 111 has a size in the range from 1 mm to 10 mm in the direction vertical to the first light emitting surface 112, a short base edge of the trapezoid has a length in the range from 0.1 mm to 2 mm and namely the first top surface 114 of the first wedge light guide plate 110 opposite to the first light incident surface 111 in the direction vertical to the first light emitting surface 112 has a size in the range from 0.1 mm to 2 mm. And for example, when the transparent display device is that of about 8 inches, the long base edge of the trapezoidal cross section of the first wedge light guide plate has a length in the range from 1.6 mm to 5 mm, and the short base edge of the trapezoidal cross section of the first wedge light guide plate has a length in the range from 0.1 mm to 1 mm.

In some examples, as illustrated by FIG. 7, a shape of the cross section of the first wedge light guide plate 110 is trapezoid, a long base edge of the trapezoid has a length in the range from 2.8 mm to 3.2 mm and namely the first light incident surface 111 has a size in the range from 2.8 mm to 3.2 mm in the direction vertical to the first light emitting surface 112, a short base edge of the trapezoid has a length in the range from 0.48 mm to 0.52 mm and namely the first top surface 114 of the first wedge light guide plate 110 opposite to the first light incident surface 111 has a size in the range from 0.48 mm to 0.52 mm in the direction vertical to the first light emitting surface 112. The height of the said trapezoid has a size in the range from 110 mm to 130 mm, and namely the first light emitting surface 112 has a size in the range from 110 mm to 130 mm in the direction vertical to the first light incident 111.

For example, the first light incident surface 111 has a size of 3 mm in the direction vertical to the first light emitting surface 112, and the first light emitting 112 has a size of 120 mm in the direction vertical the first light incident surface 111. The first wedge light guide plate 110 further includes the first top surface 114 opposite to the first light incident surface 111, and the first top surface 114 has a size of 0.5 mm in the direction vertical to the first light emitting surface 112.

In some examples, as illustrated by FIG. 7, the first light emitting surface 112 is a flat surface, and namely there is no mesh dot structure provided on the first light emitting surface 112; the first wedge light guide plate 110 has a refractive index in a range from 1.45 to 2. Additionally, there is either no mesh dot structure provided on the first inclined surface 113.

For example, the material of the first wedge light guide plate 110 is selected from materials of high light transmittance (for example, materials of light transmittance of more than 90%), such as, polymethylmethacrylate (PMMA), acrylic, polycarbonate or glass.

For example, the first wedge light guide plate 110 has materials selected from glass with a refractive index of 1.51314.

In some examples, the second wedge light guide plate 120 is made from the same materials as and has the same refractive index as the first wedge light guide plate 110.

In some examples, the second wedge light guide plate 120 can have the same shape as the first wedge light guide plate 110.

In some examples, as illustrated by FIG. 7, the backlight module 100 further includes the light source 320 which is arranged on the first light incident surface 111 of the first wedge light guide plate 110 and is configured to emit light to the first wedge light guide 110 from the first light incident surface 111. From one side where the light source 320 is arranged to its opposite side, the first wedge light guide plate has a gradually decreased thickness, and the light source 320 has a light emitting half angle in a range from 30 degrees to 65 degrees, for example 60 degrees, and namely the light source 320 can use a conventional light emitting half angle range. Additionally, in some examples, the light source 320 has a light emitting half angle in a range from 40 degrees to 50 degrees, for example 60 degrees, thus further enhancing the display effect.

The following points need to be noted:

(1) In the drawings of the embodiments of the present disclosure, only the structures related to the embodiments of the present disclosure are involved, and other structures may refer to the common design(s).

(2) In case of no conflict, features in one embodiment or in different embodiments of the present disclosure can be combined.

The above are merely particular embodiments of the present disclosure but are not limitative to the scope of the present disclosure; any of those skilled familiar with the related arts can easily conceive variations and substitutions in the technical scopes disclosed by the present disclosure, which should be encompassed in protection scopes of the present disclosure. Therefore, the scopes of the present disclosure should be defined in the appended claims.

1. A transparent display device, comprising:
a backlight module, comprising a first wedge light guide plate; and
a scattering type display panel, comprising a plurality of pixels;
wherein the first wedge light guide plate comprises a first light incident surface, a first light emitting surface, and a first inclined surface arranged oppositely to the first light emitting surface, an included angle between the first light emitting surface and the first inclined surface is an acute angle, the scattering type display panel is located on a side of the first wedge light guide plate where the first light emitting surface is located, and each of the plurality of pixels is configured to switch between a transparent state and a scattering state.

2. The transparent display device according to claim 1, wherein the first light emitting surface is a flat surface, and the first wedge light guide plate has a refractive index in a range from 1.45 to 2.

3. The transparent display device according to claim 1, further comprising:
a transparent layer, located between the scattering type display panel and the backlight module,
wherein the transparent layer is in direct contact with the first light emitting surface and the scattering type display panel respectively, and the transparent layer has a refractive index in a range from 1.30 to 1.50.

4. The transparent display device according to claim 3, wherein the transparent layer has a thickness in a range from 0.05 mm to 0.50 mm.

5. The transparent display device according to claim 1, wherein the backlight module further comprises:
a second wedge light guide plate, comprising a second inclined surface,
wherein the first wedge light guide plate and the second wedge light guide plate are disposed at an interval, and the first inclined surface is arranged to be opposite to and approximately parallel to the second inclined surface.

6. The transparent display device according to claim 5, wherein the interval between the first wedge light guide plate and the second wedge light guide plate is an air interval.

7. The transparent display device according to claim 5, wherein the second wedge light guide plate further comprises a second light incident surface which is arranged oppositely to the second inclined surface and is approximately parallel to the first light incident surface, and an included angle between the second light incident surface and the second inclined surface is an acute angle.

8. The transparent display device according to claim 1, further comprising:
a light source, arranged on the first light incident surface of the first wedge light guide plate and configured to emit light into the first wedge light guide plate from the first light incident surface, the first wedge light guide having a gradually decreased thickness from the a side where the light source is arranged to an opposite side;
wherein the light source has a light emitting half-angle in a range from 30 degrees to 65 degrees.

9. The transparent display device according to claim 8, wherein the first light incident surface is configured to receive the light emitted from the light source, the first inclined surface is configured to enable the light emitted from the light source to be totally reflected at the first inclined surface, and the first light emitting surface is configured to enable the light emitted from the light source to be emitted.

10. The transparent display device according to claim 8, wherein the light source comprises a field sequential light source.

11. The transparent display device according to claim 1, wherein the scattering type display panel further comprises:
an array substrate, comprising a first base substrate and a plurality of pixel electrodes arranged on the first base substrate;
an opposed substrate, cell-assembled with the array substrate; and
a liquid crystal layer, located between the array substrate and the opposed substrate;
wherein the liquid crystal layer comprises polymer stabilized liquid crystal or polymer dispersed liquid crystal, each of the plurality of pixel electrodes is configured to drive the polymer stabilized liquid crystal or the polymer dispersed liquid crystal to switch between a transparent state and a scattering state.

12. The transparent display device according to claim 11, wherein the opposed substrate comprises a second base substrate which has a refractive index in a range from 1.45 to 2.

13. The transparent display device according to claim 1, wherein a shape of a cross section of the first wedge light guide plate is a trapezoid, a long base edge of the trapezoid is in a range from 1 mm to 10 mm, and a short base edge of the trapezoid is in a range from 0.1 mm to 2 mm.

14. A backlight module comprising:
a first wedge light guide plate, comprising a first light incident surface, a first light emitting surface, and a first inclined surface arranged oppositely to the first light emitting surface, an included angle between the first light emitting surface and the first inclined surface being an acute angle; and
a second wedge light guide plate comprising a second inclined surface;
wherein the first wedge light guide plate and second wedge light guide plate are disposed at an interval, and the first inclined surface is arranged to be opposite to and approximately parallel to the second inclined surface.

15. The backlight module according to claim 14, wherein the interval between the first wedge light guide plate and the second wedge light guide plate is an air interval.

16. The backlight module according to claim 14, wherein the second wedge light guide plate further comprises a second light incident surface arranged oppositely to the second inclined surface and is approximately parallel to the first light incident surface, and an included angle between the second light incident surface and the second inclined surface is an acute angle.

17. The backlight module according to claim 14, wherein the first light emitting surface is a flat surface, and the wedge light guide plate has a refractive index in a range from 1.45 to 2.

18. The backlight module according to claim 17, wherein the first light emitting surface is provided with no mesh dot.

19. The backlight module according to claim 14, wherein a shape of a cross section of the first wedge light guide plate is a trapezoid, a long base edge of the trapezoid is in a range from 1 mm to 10 mm, and a short base edge of the trapezoid is in a range from 0.1 mm to 2 mm.

20. The backlight module according to claim 14, further comprising a light source, arranged on the first light incident surface of the first wedge light guide plate and is configured to emit light into the first wedge light guide plate from the first light incident surface; the first light incident surface being configured to receive the light emitted from the light source; the first inclined surface being configured to enable the light emitted from the light source to be totally reflected at the first inclined surface; and the first light emitting surface being configured to enable the light emitted from the light source to be emitted.
